(19) United States
(12) Patent Application Publication
(10) Pub. No.: US 2012/0159399 A1
(43) Pub. Date: Jun. 21, 2012

(54) SYSTEM FOR ORGANIZING AND NAVIGATING DATA WITHIN A TABLE

(75) Inventors: Paul R. Bastide, Boxford, MA (US); Matthew E. Broomhall, South Burlington, VT (US); Robert E. Loredo, Miami Beach, FL (US)

(73) Assignee: INTERNATIONAL BUSINESS MACHINES CORPORATION, Armonk, NY (US)

(21) Appl. No.: 12/972,275

(22) Filed: Dec. 17, 2010

(51) Int. Cl. G06F 17/30; G06F 3/048

(52) U.S. Cl. 715/854; 707/740; 707/E17.089

(57) ABSTRACT

A table navigation system includes: a table identifier to identify a table and columns within the table; a navigation identifier to determine whether a navigation input by a user to navigate within a column of the table exceeds a threshold, wherein the threshold relates to an expectation of continued navigation input by the user; a filter to filter unique elements in the column into separate categories; and a display engine to present the into separate categories in an interactive display that overlays the table.

### BACKGROUND

A table is a database that includes sets of related data elements. The sets of data elements or values are generally organized using a model of vertical columns and horizontal rows. Typically, a table has a specified number of columns, but may have any number of rows, such that the amount of data stored in the table may range from small to very large and may include thousands of entries, and even more. Because the table may include many entries, searching the table to find a particular entry without a keyword or other shortcut to the entry may be very time consuming and impractical, and even may result in overlooking the desired content.

Email clients, for example, or similar applications may include such tables that display information related to a particular email message or other entry. Users of email clients may receive many emails every day, which may result in an increasingly large database of emails if the users do not delete or move any of the emails. This may occur especially when the information in each email message has some importance and the users desire to save the messages for later review or for saving attachments. As the number of email messages grows, the more difficult it becomes to find old messages for review. Simplifying or streamlining the searching process may reduce search time for tables storing large amounts of data.

### SUMMARY

Embodiments of a system are described. In one embodiment, the system is a table navigation system. The system includes: a table identifier to identify a table and columns within the table; a navigation identifier to determine whether a navigation input by a user to navigate within a column of the table exceeds a threshold, wherein the threshold relates to an expectation of continued navigation input by the user; a filter to filter unique elements in the column into separate categories; and a display engine to present the into separate categories in an interactive display that overlays the table. Other embodiments of the system are also described. Embodiments of a computer program product and a method are also described. Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 depicts a schematic diagram of one embodiment of a table navigation system.

FIG. 2 depicts a schematic diagram of one embodiment of an interactive display for navigating a table.

FIG. 3 depicts a schematic diagram of one embodiment of the interactive display for navigating a table of FIG. 2.

FIG. 4 depicts a flow chart diagram of one embodiment of a method for organizing and navigating data within a table.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

While many embodiments are described herein, at least some of the described embodiments present a system and method for organizing and navigating data within a table. More specifically, the system recognizes when a user is entering navigation input to navigate the table and presents an organized view of the data for a given column in an interactive display overlaying the table. The interactive display allows the user to navigate the content of the table more quickly, rather than having to navigate through all of the irrelevant content to find the relevant content. This may be particularly useful when the user does not have keywords to go directly to the relevant content or if the user is looking for more than one related entry within the table.

As used herein and in the appended claims, the term “navigate” is to be broadly interpreted to include scrolling, paging, using arrow keys, gestures, or any other method of navigating a table that allows the user to look at some or all of the entries within a column or number of columns in the table.

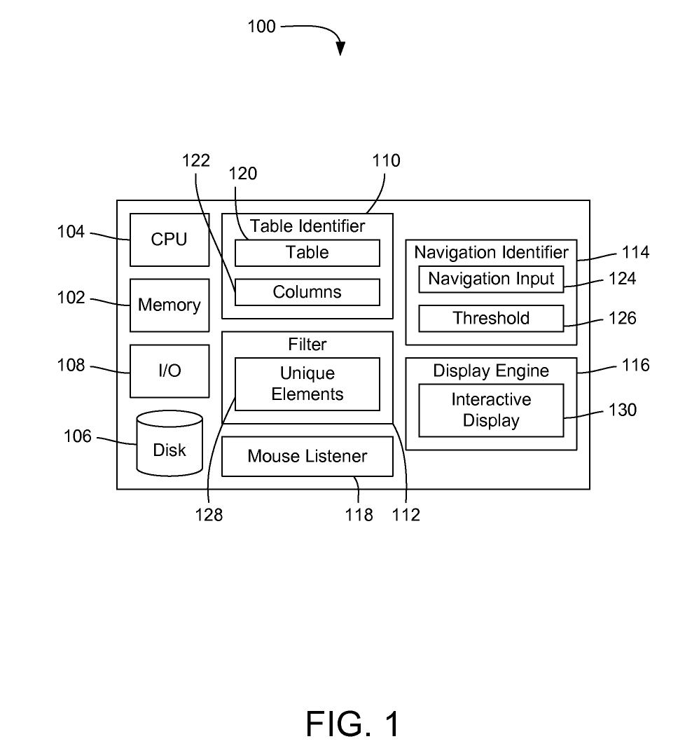

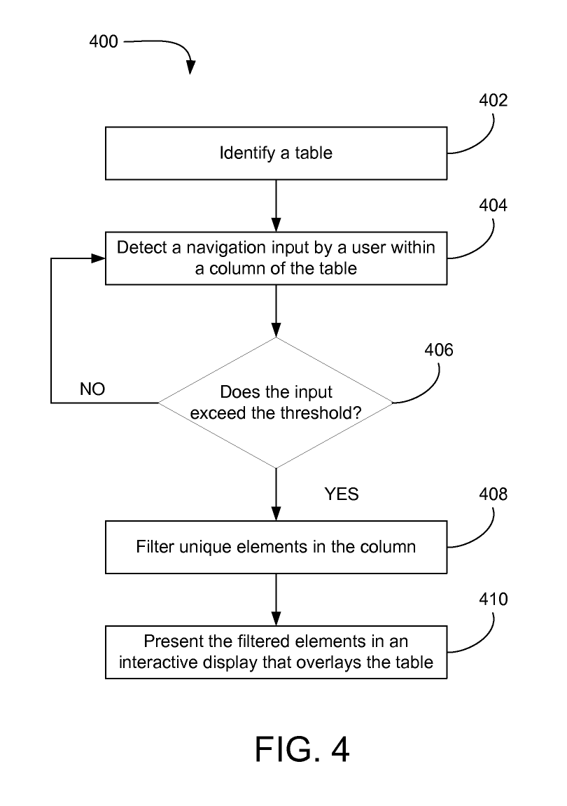

FIG. 1 depicts a schematic diagram of one embodiment of a table navigation system 100. The depicted table navigation system 100 includes various components, described in more detail below, that are capable of performing the functions and operations described herein. In one embodiment, at least some of the components of the table navigation system 100 are implemented in a computer system. For example, the functionality of one or more components of the table navigation system 100 may be implemented by computer program instructions stored on a computer memory device 102 and executed by a processing device 104 such as a CPU. The table navigation system 100 may include other components, such as a disk storage drive 106, input/output devices 108, a table identifier 110, a filter 112, a navigation identifier 114, a display engine 116, a mouse listener 118, and a display device 132. Some or all of the components of the table navigation system 100 may be stored on a single computer or on a network of computers. The table navigation system 100 may include more or fewer components than those depicted herein. In some embodiments, the table navigation system 100 may be used to implement the method described herein as depicted in FIG. 4.

The table identifier 110 identifies a table 120 database containing sets of related data. The table 120 is displayed on a display device 132, such as a monitor or screen for a computer or mobile device. In one embodiment, a set of related data is defined by all data contained within a single row over one or more columns 122 of the table 120. In other embodiments, a set of related data may include data over several rows. The table identifier 110 identifies the specific table 120 in which the user is operating. In one embodiment, this includes calculating a boundary for the table 120, such that the system 100 is able to determine the total number of cells, each cell width and height, and/or a total table 120 width and height. The table identifier 110 also identifies the number and type of columns 122 contained in the table 120. The number of columns 122 in the table 120 may be fixed or modifiable. If the number of columns 122 is modified, the table identifier 110 may re-calculate the table 120 boundary. Modifying the number of rows in the table 120 may also cause the table identifier 110 to re-calculate the table 120 boundary and/or to update information shown in the interactive display 130.

The navigation identifier 114 detects a navigation input 124 from the user. In one embodiment, the navigation input 124 includes an input from one of the input devices connected to the system 100, including a mouse, a touch screen, a keyboard, or other input devices capable of inputting a navigation input 124. The navigation input 124 may be an input from a scroll wheel of a mouse, down/up arrows or paging keys on a keyboard, gestures on a touch screen, or any other method for indicating to the system 100 that the user wants to navigate within a column 122 of the table. In one embodiment, the navigation identifier 114 compares the navigation input 124 against a threshold 126 to determine whether the navigation input 124 is sufficient to initiate the filter 112 and display engine 116.

The filter 112 filters the unique elements 128 in the column 122 in which the user is navigating. In one embodiment, the filter 112 indexes all of the elements in the column 122 to identify each of the unique elements 128. The filter 112 is able to identify each occurrence of a unique element 128, and when indexing the elements combines each occurrence of each unique element 128 into a single instance of each unique element 128 in the index. For example, if the filter 112 identifies three unique elements 128, each with multiple occurrences, the filter 112 indexes creates an index with three unique elements 128 that represent all of the multiple occurrences. In one embodiment, the filter 112 filters and indexes the elements in a column 122 after detecting the navigation input 124, such that the filtering occurs in real-time. In another embodiment, the filter 112 filters and indexes the elements in each column 122 of the table 120 in advance—such as when the table 120 or the application is opened—so that the system 100 may provide the filtered elements more rapidly when the navigation input 124 is detected.

The display engine 116 presents the filtered elements in an interactive display 130 that overlays the table 120. In one embodiment, the interactive display 130 includes a digital file index that displays the filtered elements for the given column 122 in an organized view. The digital file index may be scrollable or otherwise navigable. In one embodiment, the digital file index displays the filtered elements in alphabetical or reverse alphabetical order. The digital file index may display only a portion of the filtered data at one time, such that as the user navigates through the digital file index, the viewable portion of the filtered data changes.

In one embodiment, the navigation identifier 114 first identifies the navigation input 124 that exceeds the threshold 126, and then identifies a second navigation input in an opposite navigation direction from the first navigation input 124 before initiating the filter 112 and display engine 116 to display the filtered elements in the interactive display 130. If the navigation input continues in the original navigation direction rather than changing to the opposite navigation direction, the system 100 may be configured to disregard the filter 112 and display engine 116, so that the interactive display 130 is not presented to the user. Other methods may be used to indicate to the system 100 to display the interactive display 130 or to disregard the display 130.

The system 100 may include a mouse listener 118 that listens for a position of a mouse pointer on the table 120. The mouse listener 118 may be able to determine in which column 122 the mouse pointer is positioned. In one embodiment, the column 122 in which the mouse pointer is positioned is the column 122 in which the filter 112 will filter unique elements 128 for presentation to the user. The interactive display 130 (such as the digital file index) for that column 122 may be positioned directly over the column 122 such that the display 130 does not overlap with any other columns 122. In another embodiment, the interactive display 130 is displayed over more than one column 122.

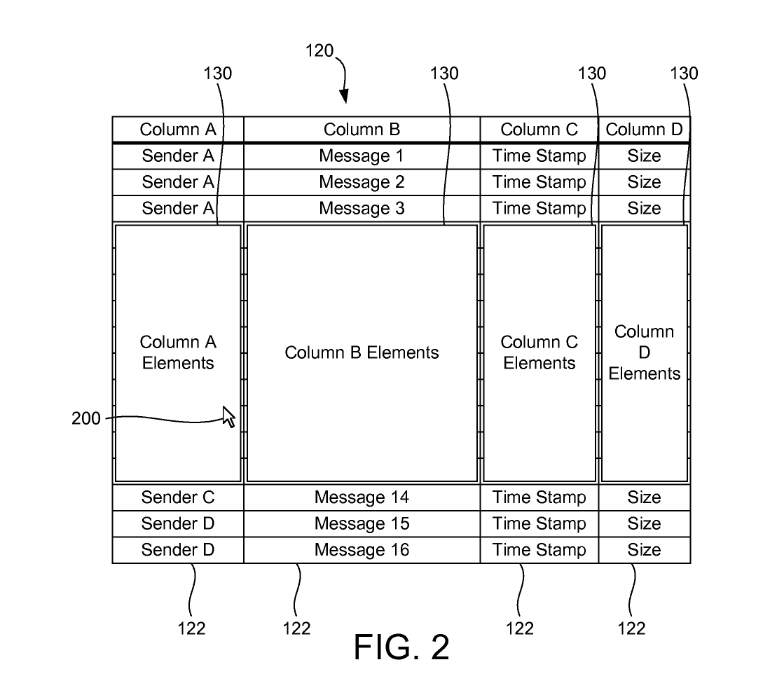

FIG. 2 depicts a schematic diagram of one embodiment of an interactive display 130 for navigating a table 120. While the interactive display 130 in the present embodiment is described with respect to the system 100 of FIG. 1, the interactive display 130 may be used in conjunction with any table navigation system 100.

The interactive display 130 may include several sections containing different elements. In one embodiment, each section in the interactive display 130 represents the elements or data for a single column 122. Each area may be displayed directly overlaying the corresponding column. Some or all sections of the interactive display 130 may be shown at a single time. The interactive display 130 is presented overlaying the table 120 when the system 100 detects a navigation input 124 that exceeds a threshold 126. The threshold 126 may be set using preferences by the user. The threshold 126 may include a time threshold 126, such that the user must perform the navigation input 124 for a time equal to or greater than the navigation input 124 before the system 100 initiates the filter 112 and display engine 116. In another embodiment, the threshold 126 includes a number of rows, such that the user must perform the navigation input 124 to navigate through a number of rows equal to or greater than the threshold 126.

In one embodiment, the table 120 is included in an email client that displays a listing of email messages for an email account. Each email message may be listed in a single row of the table 120, such that each row of the table 120 includes data relating to a single email message. For example, the table 120 may include the sender or author of the email, the message header, a time stamp of when the email was sent, a size of the email, or other information about each message. Each piece of information related to the email messages may be displayed in separate columns 122. The columns 122 may include headers that identify the contents of each column 122.

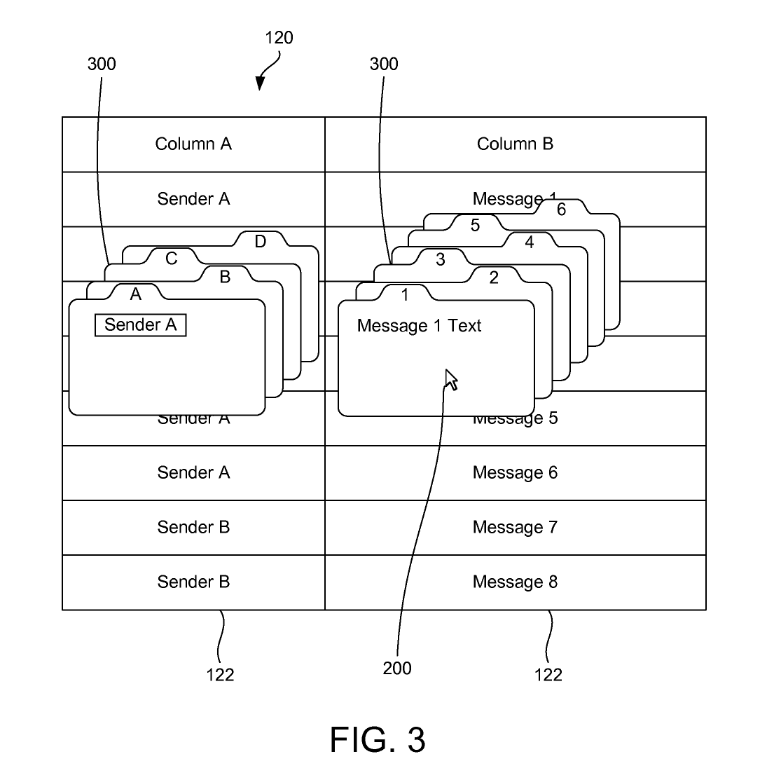

FIG. 3 depicts a schematic diagram of one embodiment of the interactive display 130 for navigating a table 120 of FIG. 2. The interactive display 130 may include a digital file index 300 or other index that presents an organized and condensed view of the contents of one or more columns 122 in the table 120. The system 100 may include multiple interactive displays 130 or multiple sections of a single interactive display 130 in a table, such that the table 120 includes a section of an interactive display 130 for each column 122. In one embodiment, the content for more than one column 122 is presented in a continuous interactive display 130.

Each column 122 may have a section of an interactive display 130 presented as a digital file index 300. The digital file index 300 for each column 122 may display only a portion of the filtered content. In one embodiment, the column data is displayed in alphabetical order, from front to back. In an email client, for example, the system 100 filters the unique elements 128 in a column 122 corresponding to the sender of the email message. After filtering the unique sender names, the digital file index 300 is displayed over the column 122 detailing the email message senders. The digital file index 300 for the column 122 displaying the sender for each mail message may have a digital file index file or folder for each letter of the alphabet and each folder may display all sender names for the corresponding letter. In some embodiments, the digital file index 300 only displays folders for letters corresponding to the data in the column. In one embodiment, the digital file index 300 displays the content in an order according to a present sorting of the content within the column 122 or table 120. For example, the table 120 may be displayed according to a time stamp column, such that the content of each column 122 is displayed in chronological time. When the digital file index 300 corresponding to a particular column 122 is displayed, the digital file index 300 may be sorted in chronological order, such that each folder displays messages for a specific date or range of dates.

The user may scroll or otherwise navigate through the digital file index 300 more quickly than the table 120 because the data is filtered and condensed according to unique elements 128. In one embodiment, the unique elements 128 are filtered by combining duplicate occurrences of each unique element 128 (corresponding to unique data in other columns 122) into a single instance in the interactive display 130. For example, every occurrence of a particular sender is combined into a single listing of the sender in the digital file index 300. The digital file index 300 may display a portion of the content at a time, such that only some of the unique elements 128 are displayed. As the user navigates through the digital file index 300, the content displayed in the digital file index 300 may change.

In one embodiment, the second digital file index 300 presents all elements from the second column 122 corresponding to a unique element 128 from the first column 122 that is displayed in the first digital file index 300. Consequently, the elements in the second column 122 may be filtered by matching any elements in the second column 122 to the highlighted element from the first digital file index 300 and then sorting these elements and displaying them in the second digital file index 300. Highlighting a different element in the first digital file index 300 may then change the content displayed in the second digital file index 300. In one embodiment, the content in the second element is organized and displayed according to a time stamp. Other embodiments may organize and display the content according to some other rule.

In one embodiment, the system 100 may detect that the user is scrolling in the second column 122 of a table 120. When the navigation input 124 exceeds the threshold 126, the filter 112 may filter the unique elements 128 of the second column 122 and display the filtered elements in an interactive display 130 over the second column 122. Highlighting one of the unique elements 128 in the second digital file index 300 may cause the system 100 to display a digital file index 300 for the first column 122 or any other column 122 within the table 120. For example, if the user scrolls in the column 122 corresponding to email message headers, highlights the column 122 heading or highlights the entire column 122 and begins to scroll down the list of email messages, the system 100 may filter the email messages according to headers and place repeated message headers or similar message headers in a single listing in the digital file index 300. When the user selects a particular message header, the system 100 may present a digital file index 300 in the first column corresponding to the email senders or other correspondence for the similar group of email messages. The system 100 may alternatively present a digital file index 300 for columns 122 after the second column 122 rather than or in addition to the first column 122. In another embodiment, highlighting an element in the table and then performing the navigation input 124 displays the digital file index 300 for the column 122 where the element is highlighted, and at least a second digital file index 300 may be displayed for elements in other columns 122 that correspond to the element highlighted in the table 120.

In one embodiment, the user may navigate through each displayed digital file index 300 by pointing the mouse pointer 200 over the desired digital file index 300. For example, when the mouse pointer 200 hovers over a first digital file index 300, using the scroll wheel on the mouse navigates through the first digital file index 300. Moving the mouse pointer 200 to a second digital file index 300 and using the scroll wheel navigates through the second digital file index 300. In one embodiment, scrolling in one direction navigates through each filtered element in every folder. Scrolling in the opposite direction navigates through the folders, rather than each unique element 128, and consequently navigates through the folders faster than navigating through each filtered element within the folders. In another embodiment, scrolling in one direction navigates through the first digital file index 300 in a single direction, and scrolling in the opposite direction switches to the second digital file index 300 and navigates through the second digital file index 300. The user may exit out of the interactive display 130 by clicking outside of the display boundary, by selecting to view a particular element, or by other methods. Selecting a particular element for viewing may take the user directly to the row in the table 120 where the element is stored. In another embodiment, selecting a particular table element, such as an email message, in a digital file index 300 opens the email message directly. Multiple digital file indexes 300 may be displayed in any order, including layered on top of one another, beside each other, above the corresponding column, or otherwise.

FIG. 4 depicts a flow chart diagram of one embodiment of a method 400 for organizing and navigating data within a table 120. Although the method 400 is described in conjunction with the table navigation system 100 of FIG. 1, embodiments of the method 400 may be implemented with other types of table navigations systems 100.

The table navigation system 100 first identifies 402 a table 120. In some embodiments, the system 100 may also identify columns 122 and rows within the table 120, such that the system 100 is able to determine a table boundary and/or column boundaries. The boundaries may be defined by pixel width and height and/or number of entries in each column or row. In some embodiments, the system 100 may also identify an ordering of the data within the table 120 or within each column 122 for later use in an interactive display 130.

The system 100 detects 404 a navigation input 124 by a user within a column 122 of the table 120. The navigation input 124 may be a scrolling action by a scroll wheel, keyboard keys, gestures or other navigation inputs 124. The system 100 may be able to detect where the mouse pointer 200 is positioned on the table 120, including the column 122. The system 100 may also be able to detect whether a column 122, row, cell or group of cells is highlighted, which may aid the filter 112. The system 100 checks 406 to determine if the navigation input 124 exceeds a threshold 126. The type and value of the threshold 126 may be determined by the user. The threshold 126 may include a time threshold or a pixel/row threshold, such that if the navigation input 124 exceeds the time or pixel value, the system 100 will recognize that the input 124 has exceeded the threshold 126 and continues onto further steps of the method 400.

If the navigation input 124 does not exceed the threshold 126, the system 100 returns to detecting 404 a navigation input until the navigation input 124 exceeds the threshold 126. In some embodiments, even when the input 124 exceeds the threshold 126, the system 100 may require an additional input, such as an opposite navigation input 124 after an original navigation input 124 exceeds the threshold 126 before the system 100 activates the filter 112 and display engine 116. In one embodiment, if the user does not input an additional input or opposite navigation input 124, the system 100 continues scrolling through the table 120 without displaying the interactive display 130 over the table 120.

The system 100 then filters 408 unique elements 128 in the column 122 where the navigation input 124 is detected. Each unique element 128 may include more than one occurrence in the column 122, such that the table 120 may contain many more rows than unique elements 128. The table 120 may filter the elements and organize the elements according to preferences. After filtering the elements, the system 100 presents 410 the filtered elements in an interactive display 130 that overlays the table 120. In one embodiment, the interactive display 130 includes a scrollable or navigable digital file index 300.

The filtered elements in the interactive display 130 may be organized and displayed in an alphabetical or reverse-alphabetical order. In another embodiment, the filtered elements may be displayed in an order determined by the order of the columns 122 in the table 120. For example, if the table 120 is organized in a chronological order, the filtered elements may be organized in a chronological order. In other embodiments, the filtered elements may be displayed in an order set by preferences. The system 100 may have default preferences for the threshold 126, navigation input 124 that trigger the system 100, organization of content in the interactive display 130, and other behaviors of the system 100. In one embodiment, the filtered elements in the interactive display 130 are displayed in a hierarchical order according to specified criteria in each cell. The filtered elements may alternatively be organized and displayed in a manner other than those described herein.

The method 400 may include more than one interactive display 130 in the table, or more than one section for the interactive display 130. In one embodiment, an interactive display 130 is shown for each column 122 that the user desires to navigate. In another embodiment, the method 400 includes a single interactive display 130 including several digital file indexes 300 or other navigable indexes, such that a single interactive display 130 may overlay more than one column 122 within the table 120. In one embodiment, the user may close the interactive display 130 by selecting an element within the display 130 and performing an action to open a file related to the element or to jump to the element in the table 120. In another embodiment, the user may close the interactive display 130 by clicking a “close” option or by clicking outside of the interactive display 130.

In one embodiment of the method 400, the table navigation system 100 may index the entire table 120 and store the data in a tree structure. The tree structure may include root levels for each of the unique elements in a first column 122 and secondary levels for each row having data corresponding to one of the unique elements 128, particularly in embodiments where the system 100 filters the unique elements in the first column 122 by grouping repeating occurrences of a unique element under one listing of the unique element 128. The indexing or filtering structure may be stored and modified when data within the table 120 is modified. In one embodiment, some or all of the tree structure may be shared with another computing device or application.

An embodiment of a table navigation system 100 includes at least one processor coupled directly or indirectly to memory elements through a system bus such as a data, address, and/or control bus. The memory elements can include local memory employed during actual execution of the program code, bulk storage, and cache memories which provide temporary storage of at least some program code in order to reduce the number of times code must be retrieved from bulk storage during execution.

It should also be noted that at least some of the operations for the methods may be implemented using software instructions stored on a computer useable storage medium for execution by a computer. As an example, an embodiment of a computer program product includes a computer useable storage medium to store a computer readable program that, when executed on a computer, causes the computer to perform operations, including an operation to organize and navigate data within a table. The operations are able to identify a table, detect a navigation input within a column of the table that exceeds a threshold, filter unique elements in the column, and present the filtered elements in an interactive display that overlays the table.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Embodiments of the invention can take the form of an entirely hardware embodiment, an entirely software embodiment, or an embodiment containing both hardware and software elements. In one embodiment, the invention is implemented in software, which includes but is not limited to firmware, resident software, microcode, etc.

Furthermore, embodiments of the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The computer-useable or computer-readable medium can be an electronic, magnetic, optical, electromagnetic, infrared, or semiconductor system (or apparatus or device), or a propagation medium. A computer readable storage medium is a specific type of computer-readable or -usable medium. Examples of a computer-readable storage medium include a semiconductor or solid state memory, magnetic tape, a removable computer diskette, a random access memory (RAM), a read-only memory (ROM), a rigid magnetic disk, and an optical disk. Hardware implementations including computer readable storage media also may or may not include transitory media. Current examples of optical disks include a compact disk with read only memory (CD-ROM), a compact disk with read/write (CD-R/W), and a digital video disk (DVD).

Input/output or I/O devices (including but not limited to keyboards, displays, pointing devices, etc.) can be coupled to the system either directly or through intervening I/O controllers. Additionally, network adapters also may be coupled to the system to enable the data processing system to become coupled to other data processing systems or remote printers or storage devices through intervening private or public networks. Modems, cable modems, and Ethernet cards are just a few of the currently available types of network adapters.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A computer program product, comprising:
a computer readable storage medium to store a computer readable program, wherein the computer readable program, when executed on a processor within a computer, causes the computer to perform operations for organizing and navigating data within a table, the operations comprising:
displaying the table on a display device;
determining whether a navigation input by a user to navigate entries within a column of the table exceeds a threshold, wherein the threshold relates to an expectation of continued navigation input by the user;
filtering unique elements in the column into separate categories; and
presenting the separate categories in an interactive display that overlays the table.

2. The computer program product of claim 1, wherein the computer program product, when executed on a processor within the computer, causes the computer to perform additional operations, comprising:
receiving input from the user to navigate categories within the interactive display.

3. The computer program product of claim 1, wherein the interactive display comprises a digital file index showing at least a portion of the separate categories in an indexed view, wherein the digital file index is navigable.

4. The computer program product of claim 1, wherein the separate categories are displayed in alphabetical, reverse alphabetical, or chronological order.

5. The computer program product of claim 1, wherein the computer program product, when executed on a processor within the computer, causes the computer to perform additional operations, comprising:
receiving an additional input in an opposite navigation direction from the navigation input before presenting the interactive display on the table.

6. The computer program product of claim 1, wherein the computer program product, when executed on the computer, causes the computer to perform additional operations, comprising:
indexing related elements in a second column corresponding to a unique element of the first column in response to selecting the unique element of the first column;
presenting the related elements of the second column in the interactive display.

7. The computer program product of claim 6, wherein the related elements of the second column are displayed in a separate interactive display than the separate categories of the first column.

8. A method for organizing and navigating data within a table, the method comprising:
displaying the table on a display device;
determining whether a navigation input by a user to navigate entries within a column of the table exceeds a threshold, wherein the threshold relates to an expectation of continued navigation input by the user;
filtering unique elements in the column into separate categories; and
presenting the separate categories in an interactive display that overlays the table.

9. The method of claim 8, further comprising:
receiving input from the user to navigate categories within the interactive display.

10. The method of claim 8, wherein the interactive display comprises a digital file index showing at least a portion of the separate categories in an indexed view, wherein the digital file index is navigable.

11. The method of claim 8, wherein the separate categories are displayed in alphabetical, reverse alphabetical, or chronological order.

12. The method of claim 8, further comprising:
receiving an additional input in an opposite navigation direction from the navigation input before presenting the interactive display on the table.

13. The method of claim 8, wherein the computer program product, when executed on the computer, causes the computer to perform additional operations, comprising:
indexing related elements in a second column corresponding to a unique element of the first column in response to selecting the unique element of the first column;
presenting the related elements of the second column in the interactive display.

14. The method of claim 13, wherein the related elements of the second column are displayed in a separate interactive display than the separate categories of the first column.

15. A table navigation system, comprising:
a table identifier to identify a table and columns within the table;
a navigation identifier to determine whether a navigation input by a user to navigate within a column of the table exceeds a threshold, wherein the threshold relates to an expectation of continued navigation input by the user;
a filter to filter unique elements in the column into separate categories; and
a display engine to present the separate categories in an interactive display that overlays the table.

16. The system of claim 15, wherein the interactive display comprises a digital file index showing at least a portion of the separate categories in an indexed view, wherein the digital file index is navigable.

17. The system of claim 15, wherein the navigation identifier is further configured to receive an additional input in an opposite navigation direction from the navigation input before presenting the interactive display on the table.

18. The system of claim 15, wherein the filter is further configured to filter related elements in a second column, wherein the related elements correspond to a selected category.

19. The system of claim 18, wherein the filter is further configured to filter all data in the table and index the data in a tree structure, wherein level in the tree structure is represented by a column.

20. The system of claim 15, further comprising a mouse listener to determine where a mouse cursor is positioned, wherein a position of the mouse cursor determines the column to be filtered by the filter and displayed in the interactive display.
